(19) United States
(12) Patent Application Publication
(10) Pub. No.: US 2002/0157493 A1
(43) Pub. Date: Oct. 31, 2002

(54) Automatic transmission shift lever device

(76) Inventors: Ryoichi Fujiwara, Shizuoka-ken (JP); Yoshimasa Kataumi, Fukaya-shi (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/107,550

(22) Filed: Mar. 27, 2002

(30) Foreign Application Priority Data
Mar. 28, 2001 (JP) P2000-094123

(51) Int. Cl. G05G 9/00; B60K 20/00

(52) U.S. Cl. 74/473.1

(57) ABSTRACT

An automatic transmission shift lever device which includes a shift lever, a base bracket and a boot. The base bracket supports the shift lever and is provided with a hole with a hook protruding inward from an inner circumference of the hole. The boot made of an elastic material covers the bottom of the base bracket and is provided with a protrusion. The hook digs into the protrusion inserted into the hole so as to prevent the protrusion from coming off.

### BACKGROUND OF THE INVENTION

1. Field of the Invention

The present invention relates to an automatic transmission shift lever device provided with a boot for dustproofing and the like.

2. Description of Related Art

To date, automatic transmission shift lever devices have been made in various forms. A boot made of an elastic material such as rubber covers the bottom of a base bracket supporting a shift lever on the floor of an automobile, and prevents the permeation of fluids or the invasion of dust into the base bracket from an opening in the automobile floor. The base bracket has a hole for fitting the boot and the boot has a protrusion to be inserted into the hole.

In a conventional automatic transmission shift lever device, the protrusion of the boot has a part with an enlarged diameter in a central portion in the axial direction thereof, which is retained in the hole of the base bracket, whereby the boot is fixed to the base bracket. In order to retain the enlarged part in the hole, it is necessary to pull a tip of the protrusion with pincers or the like after inserting the protrusion into the hole. As a tool is required for such retention, the number of assembly steps cannot be reduced.

### SUMMARY OF THE INVENTION

An object of the present invention is to provide an automatic transmission shift lever device which contributes to reduction of assembly steps.

A first aspect of the present invention is an automatic transmission shift lever device comprising: a shift lever; a base bracket supporting the shift lever, the base bracket being provided with a hole having a hook protruding inward from an inner circumference of the hole and a boot of an elastic material covering the bottom of the base bracket, the boot being provided with a protrusion, wherein the hook digs into the protrusion inserted into the hole so as to prevent the protrusion from coming off.

According to the first aspect having the above-described constitution, the hook protrudes inward from the inner circumference of the hole of the base bracket, whereby the hook digs into the protrusion inserted into the hole and prevents the protrusion from coming off. Accordingly, the boot can be fixed to the base bracket simply by inserting the protrusion into the hole. Use of a tool is not necessary for the insertion. The protrusion should be just long enough to reach the hook in the hole and for the hook to dig thereinto. Therefore, the assembly process and the form of the protrusion are simplified, thereby reducing manufacturing cost.

A second aspect of the present invention is the automatic transmission shift lever device according to the first aspect, in which the hook is configured with a lower side and an upper side, the lower side and the upper side being inclined upward, and the lower side and the upper side at a distance from the inner circumference of the hole approach each other, as the distance increases.

According to the second aspect, since the hook has the lower side and the upper side, and the lower side and the upper side at a distance from the inner circumference of the hole approach each other as the distance increases, the hook has a very small area of contact with the protrusion. Therefore, the protrusion can be inserted into the hole smoothly. Moreover, as the hook is formed into a pointed shape, the hook easily digs into the protrusion and securely fixes the protrusion to the hole. Since the lower side of the hook is inclined upward, the protrusion can be inserted into the hole smoothly. Since the upper side of the hook is inclined upward, the hook presents a great resistance to the extraction of the protrusion from the hole because of the hook digging into the protrusion. Therefore, the hook securely fixes the protrusion to the hole.

A third aspect of the present invention is the automatic transmission shift lever device according to the first aspect, in which the hook is configured with lateral sides, the lateral sides at a distance from the inner circumference of the hole approach each other, as the distance increases.

According to the third aspect, since the hook has the lateral sides, and the lateral sides at a distance from the inner circumference of the hole approach each other as the distance increases, the hook has a very small area of contact with the protrusion. Therefore, the protrusion can be inserted into the hole further smoothly. Moreover, as the hook is formed into a pointed shape, the hook easily digs into the protrusion and further securely fixes the protrusion to the hole.

A fourth aspect of the present invention is the automatic transmission shift lever device according to the first aspect, in which a plurality of the hooks are provided with spaces on the inner circumference of the hole.

According to the fourth aspect, since the hooks are provided with spaces on the inner circumference of the hole, the protrusion is held in a stable position. Since any contact force of the hook onto the protrusion is not localized, the durability of the protrusion is enhanced.

A fifth aspect of the present invention is the automatic transmission shift lever device according to the first aspect, in which the protrusion is configured with an introductory portion tapered toward a tip thereof.

According to the fifth aspect, since the protrusion has the introductory portion tapered toward the tip thereof, the protrusion can be readily led into the hole.

A sixth aspect of the present invention is the automatic transmission shift lever device according to the first aspect, in which the protrusion is configured with a cavity extending along an axis of the protrusion.

According to the sixth aspect, since the protrusion is provided with a cavity extending along the axis of the protrusion, the protrusion becomes more flexible. And the protrusion easily deforms by contact to the hook at the insertion, and the spring-back of the protrusion due to the compression in an axial direction is prevented. This flexibility presents smooth insertion of the protrusion. The cavity can also be used for positioning the protrusion at the insertion, thus facilitating the assembly process.

### BRIEF DESCRIPTION OF THE DRAWINGS

The invention will now be described with reference to the accompanying drawings wherein:

FIG. 1 is an exploded perspective view of an automatic transmission shift lever device disclosed as one embodiment of the invention;

FIGS. 2A and 2B are views showing the automatic transmission shift lever device, in which FIG. 2A is a plan view showing a hole of a base bracket and FIG. 2B is a cross-sectional view of the substantial parts showing a state before inserting a protrusion of a boot into the hole of the base bracket; and

FIGS. 3A and 3B are also views showing the automatic transmission shift lever device, in which FIG. 3A is a plan view showing the hole of the base bracket after inserting the protrusion of the boot and FIG. 3B is a cross-sectional view of the substantial parts showing a state after inserting the protrusion of the boot into the hole of the base bracket.

### DETAILED DESCRIPTION OF THE PREFERRED EMBODIMENT

An embodiment of the present invention will be explained below with reference to the drawings, wherein like members are designated by like reference characters.

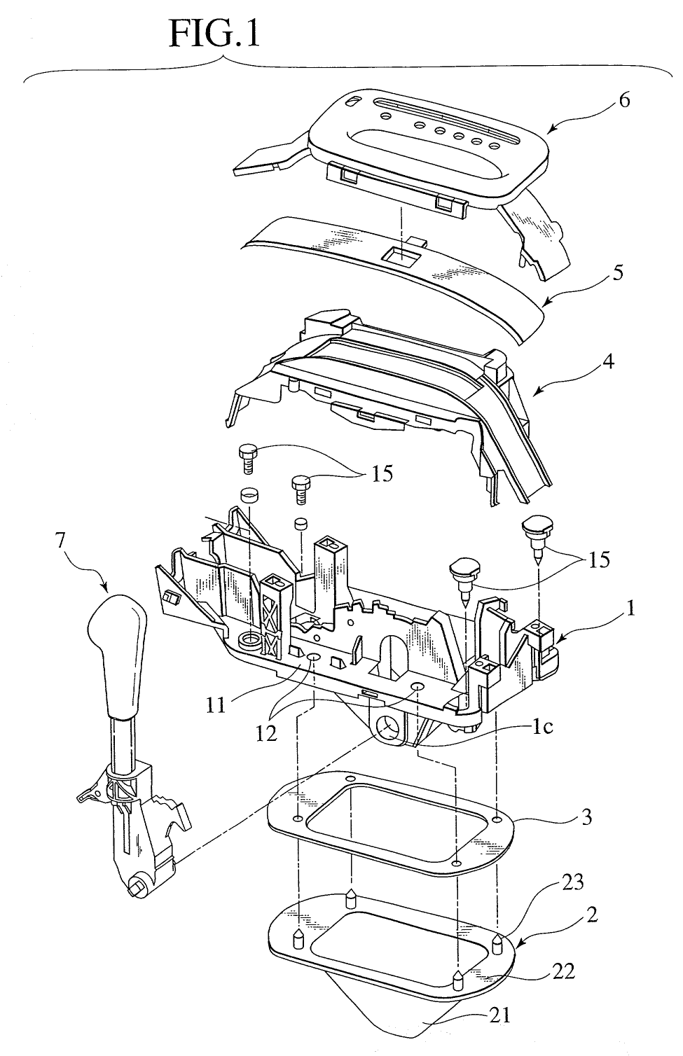

As shown in FIG. 1, an automatic transmission shift lever device disclosed in this embodiment includes a base bracket 1, a boot 2 and a shift lever 7. The base bracket 1 is fixed to a floor (not shown) of an automobile for supporting the bottom end of the shift lever 7. The base bracket 1 is extended out from the floor downward, and the bottom thereof is covered with the boot 2 made of an elastic material such as rubber. A lower end of the shift lever 7 is rotatably supported by a pivot support 1c of the base bracket 1 so that the shift lever 7 can swing in the longitudinal direction of the automobile. A flat plate 3 is interposed between the boot 2 and the base bracket 1 for the tight attachment of the boot 2 to the floor. A lower cover 4 of an indicator for indicating shift positions and the like, is mounted on the base bracket 1. An upper cover 6 has an indicator portion. A slide plate 5 is interposed between the upper cover 6 and the lower cover 4 so as to be slidable in the longitudinal direction.

The base bracket 1 is integrally formed of resin, and a flat portion 11 thereof is fixed to the floor with bolts 15. A part of the base bracket 1 having the pivot support 1c is extended downward from an aperture in the floor. The boot 2 covers the extended part and prevents it from being soiled by water, dust and the like. The flat portion 11 has holes 12 at four positions, for fitting the boot 2 thereon from beneath.

The boot 2 is integrally formed with a vessel shaped cover 21 for covering the pivot support 1c, a flat flange portion 22 around an aperture of the cover 21, and four protrusions 23 protruding upward from the flange portion 22. The respective protrusions 23 are located in positions corresponding to the above-described holes 12, and the protrusions 23 are formed so as to fit into the respective holes 12 from beneath. Note that the above-described plate 3 is interposed between the flat portion 11 and the flange portion 22. This is because a bottom face of the flat portion 11 has grid patterns and the plate 3 is interposed therebetween to obtain the tightness of the attachment of the boot 2 to the floor. If the tightness can be otherwise obtained, the plate 3 may be omitted.

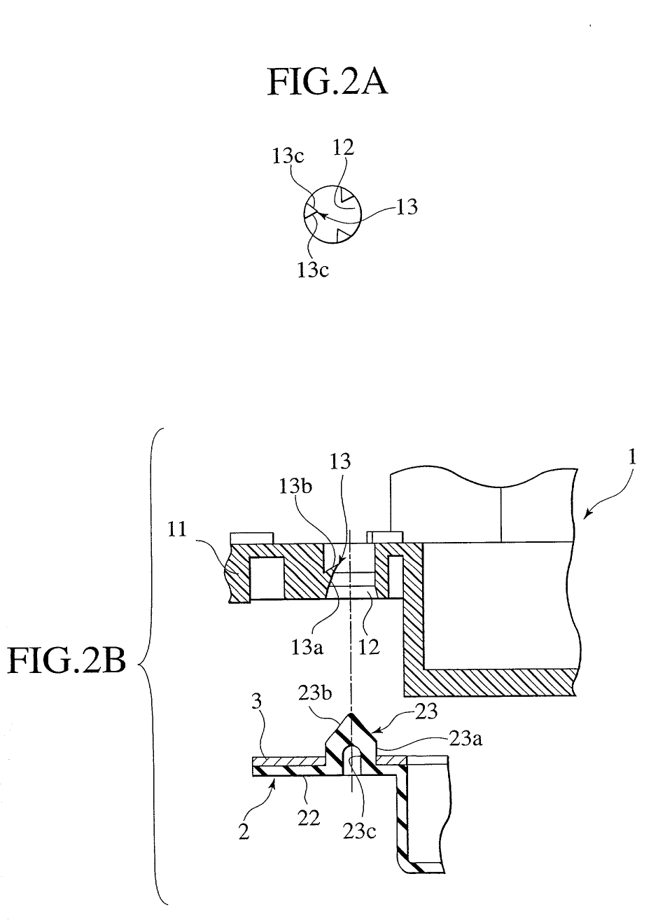

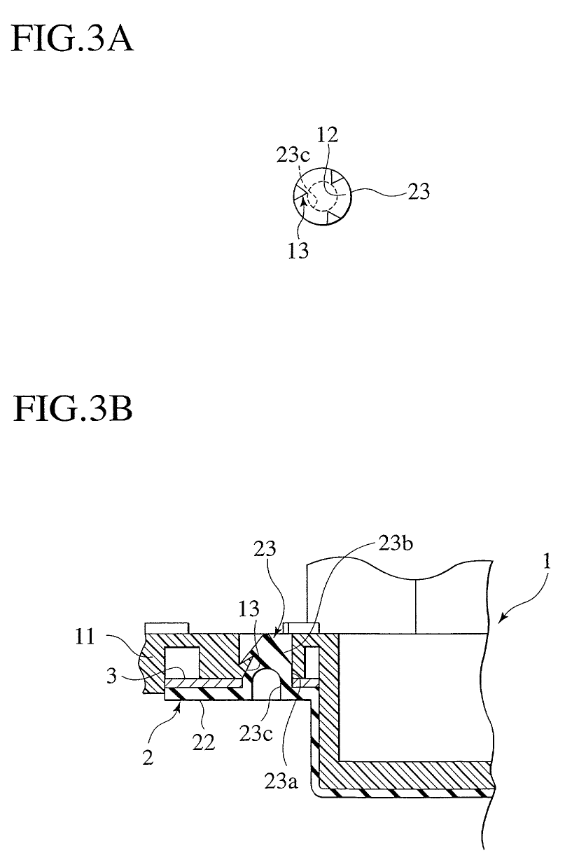

As shown in FIGS. 2A and 2B and FIGS. 3A and 3B, the hole 12 has a circular shape.

A hook 13 protrudes inward from the inner circumference of the hole 12, which is designed to dig into the protrusion 23 inserted into the hole 12 to prevent the protrusion 23 from coming off.

Both a lower side 13a and an upper side 13b of the hook 13 are linearly inclined upward, and the lower side 13a and the upper side 13b at a distance from the inner circumference of the hole 12 gradually approach each other as the distance increases. And the lower side 13a and the upper side 13b form the hook in a pointed shape. In addition, lateral sides 13c of the hook 13 at a distance from the inner circumference of the hole 12 gradually approach each other as the distance increases, whereby the hook in a pointed shape is formed. Moreover, a plurality of the hooks 13 are provided on the inner circumference of the hole 12 with equal spaces therebetween (three hooks 13 are provided in trisected positions in this embodiment).

Meanwhile, the protrusion 23 has an outer surface 23a in a cylindrical shape, and at the upper end of the outer surface 23a, a cone-shaped introductory portion 23b gradually tapering upward is formed. Moreover, formed in the protrusion 23 is a cavity 23c extending upward from the lower face of the flange portion 22 along a vertical axis of the protrusion 23. This cavity 23c extends to approximately the same height as the outer surface 23a. The protrusion 23 is designed to have a height such that an apex of the introductory portion 23b reaches as high as or below the upper face of the flat portion 11 when the protrusion 23 is inserted into the hole 12 in a state where the plate 3 is interposed between the flat portion 11 and the flange portion 22. Moreover, the hook 13 is positioned in the height direction inside the hole 12 so that the hook 13 can dig into the outer surface 23a of the protrusion 23.

In automatic transmission shift lever device having the above-described constitution, the hook 13 is provided for preventing the protrusion 23 from coming off downward from the hole 12, by digging into the protrusion 23 which is inserted into the hole 12. Accordingly, the boot 2 can be fixed to the base bracket 1 simply by inserting the protrusion 23 into the hole 12.

Therefore, the single step of inserting the protrusion 23 into the hole 12 is only required as the assembly process and no tools are needed in this case, thus reducing assembly steps. In addition, the protrusion 23 need not be long enough to have a part extended out of the hole 12 for being pinched and pulled when inserting the protrusion 23 in the hole 12. It is satisfactory that the protrusion 23 is long enough to reach the hook 13 and for the hook 13 to dig thereinto. Accordingly, the boot of this embodiment has good molding efficiency and achieves a reduction in a mold cost. Further, the automation of assembly to fit the boot 2 to the base bracket 1 also becomes feasible.

Moreover, the lower side 13a and the upper side 13b of the hook 13 are linearly inclined upward, and the lower side 13a and the upper side 13b at a distance from the inner circumference of the hole 12 gradually approach each other as the distance increases, and the lower side 13a and the upper side 13b form the hook in a pointed shape. Thus, the hook hardly constitutes any resistance upon insertion of the protrusion 23 into the hole 12 but constitutes enormous resistance upon extraction of the protrusion 23 from the hole 12 as the hook 13 digs into the protrusion 23. Accordingly, it is possible to readily insert the protrusion 23 into the hole 12 and to securely fix the protrusion 23 to the hole 12.

Furthermore, since the lateral sides 13c of the hook 13 at a distance from the inner circumference of the hole 12 gradually approach each other as the distance increases, and the hook is formed in a pointed shape, a contact area of the protrusion 23 with the lower side 13a of the hook 13 is reduced. For this reason, the resistance upon insertion of the protrusion 23 into the hole 12 is further reduced. Moreover, since the hook 13 also has a pointed shape with respect to the lateral direction thereof, the hook 13 can dig into the protrusion 23 more easily. Therefore, it is possible to insert the protrusion 23 into the hole 12 more easily and to fix the protrusion 23 more securely to the hole 12.

Moreover, since the hooks 13 are provided in the trisected positions on the inner circumference of the hole 12, it is possible to hold the protrusion 23 in a stable position. Accordingly, localized contact force will not be applied to the protrusion 23 by the hook 13, and the durability of the protrusion 23 is enhanced. Therefore, it is possible to prevent a situation where the hook 13 generates a crack on the protrusion 23 and the protrusion 23 comes off the hole 12 due to the crack.

Moreover, since the upper end of the protrusion 23 is formed into the cone-shaped introductory portion 23b, it is possible to insert the protrusion 23 easily into the hole 12.

Furthermore, since the cavity 23c is formed in the protrusion 23, it is easy to check the position of the protrusion 23 by touching a part of the cavity 23c from the bottom side of the flange portion 22 with fingers, for example. In addition, utilizing the cavity 23c, positioning of the protrusion 23 can be readily performed when automated assembly is carried out. Moreover, in case the outside diameter of the protrusion 23 is larger than the inside diameter of the hole 12, the protrusion 23 can still be inserted because the protrusion is inwardly deformable by virtue of the cavity 23c, and the spring-back of the protrusion 23 in the direction of insertion by elastic compression can be also prevented. Therefore, it is possible to securely fix the boot 2 to the base bracket 1.

The invention may be practiced or embodied in other ways without departing from the spirit or essential character thereof. The above-described embodiment disclosed an example in which four holes 12 and four protrusions 23 are provided, respectively. However, the number of the holes 12 and the protrusions 23 is not limited to the foregoing. Meanwhile, it is not always necessary to provide a hook 13 in every hole 12, but it is also possible to have a constitution in which one hook 13 is provided in every two adjacent holes 12.

Moreover, a description has been made regarding the example of providing three hooks 13 in each hole 12. However, it is satisfactory that at least one hook 13 is provided; therefore, a constitution including two or more hooks 13 may be also adoptable. Nevertheless, it is preferable that two or more hooks 13 are provided in positions equally spaced on the inner circumference of the hole 12 in terms of holding the protrusion 23 in good balance. Moreover, the hook 13 is formed into a quadrangular pyramid shape consisting of the upper and lower sides 13a and 13b and the lateral sides 13c, however, the hook 13 may be formed into a triangular pyramid shape consisting of an upper side and two inclined sides.

Moreover, although the introductory portion 23b is formed into a cone shape, the introductory portion may be formed into a hemispherical shape. Furthermore, the hole 12 and the protrusion 23 may include a polygonal inner surface or outer surface.

Furthermore, the automatic transmission shift lever device may have a constitution in which at least one pair out of the plural pairs of the holes 12 and the protrusions 23 is formed with a different diameter or a polygon of a different number of angles or the like, whereby the respective protrusions 23 can be inserted only into proper holes 12.

The preferred embodiments described herein are therefore illustrative and not restrictive, the scope of the invention being indicated by the claims, and all variations which come within the meaning of claims are intended to be embraced herein.

What is claimed is:

1. An automatic transmission shift lever device comprising:
a shift lever;
a base bracket supporting the shift lever, the base bracket being provided with a hole having a hook protruding inward from an inner circumference of the hole; and
a boot of an elastic material covering the bottom of the base bracket, the boot being provided with a protrusion, wherein
the hook digs into the protrusion inserted into the hole so as to prevent the protrusion from coming off.

2. The automatic transmission shift lever device according to claim 1, wherein the hook is configured with a lower side and an upper side, the lower side and the upper side being inclined upward, and the lower side and the upper side at a distance from the inner circumference of the hole approach each other, as the distance increases.

3. The automatic transmission shift lever device according to claim 1, wherein the hook is configured with lateral sides, the lateral sides at a distance from the inner circumference of the hole approach each other, as the distance increases.

4. The automatic transmission shift lever device according to claim 1, wherein a plurality of the hooks are provided with spaces on the inner circumference of the hole.

5. The automatic transmission shift lever device according to claim 1, wherein the protrusion is configured with an introductory portion tapered toward a tip thereof.

6. The automatic transmission shift lever device according to claim 1, wherein the protrusion is configured with a cavity extending along an axis of the protrusion.
